(19) United States
(12) Patent Application Publication
(10) Pub. No.: US 2007/0196664 A1
(43) Pub. Date: Aug. 23, 2007

(54) Epoxy resin composition and semiconductor device

(76) Inventor: Hiroki Nikaido, Tochigi (JP)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 10/592,643

(22) PCT Filed: Mar. 15, 2005
(86) PCT No.: PCT/JP05/04555

§ 371 Date: Sep. 12, 2006

(30) Foreign Application Priority Data
Mar. 16, 2004 (JP) 2004-075414

(51) Int. Cl. B32B 27/38; C08L 63/00; C08L 83/04; B32B 37/00

(52) U.S. Cl. 428/413; 428/447; 525/476

(57) ABSTRACT

An epoxy resin composition for semiconductor encapsulation which has good solder heat resistance and excellent productivity, and a semiconductor device. An epoxy resin composition is described for semiconductor encapsulation comprising (A) an epoxy resin, (B) a phenolic resin, (C) (C-1) an organopolysiloxane having a carboxyl group and/or (C-2) a reaction product between an organopolysiloxane having a carboxyl group and an epoxy resin, and (D) a tri-fatty acid ester of glycerol.

### FIELD OF THE INVENTION

The present invention relates to an epoxy resin composition for semiconductor encapsulation, and a semiconductor device.

### DESCRIPTION OF THE RELATED ART

Recently, in connection with a market trend to make electronic equipment smaller in size, lighter in weight and higher in performance, the integration of semiconductors is becoming higher year after year, and the surface mounting of semiconductor packages has been promoting. Furthermore, corporate activities under the consideration of global environment have been regarded as important, and it has been desired to completely abolish the use of lead, which is a toxic substance, except for specific purposes by 2006. Since the melting point of lead-free solder is higher than that of conventional lead/tin solder, the temperature at the time of solder-mounting operations, such as infrared ray reflow and solder dipping, will rise from a conventional temperature of 220 to 240° C. to a temperature of 240 to 260° C. in future. Such a rise in the mounting temperature causes a problem that a resin portion of a semiconductor device is cracked at the time of mounting so that the reliability of the semiconductor device cannot be guaranteed. Moreover, from the viewpoint of lead-free, the use of lead frames subjected to nickel/palladium plating beforehand instead of outer packaging solder plating has been advanced. The nickel/palladium plating has a low adhesiveness to an epoxy resin composition. Thus, delamination between them is easily caused at the time of mounting, and the resin portion is easily cracked.

Against such problems, the rise in the mounting temperature has been coped with by using an epoxy resin composition having low water absorption and low elastic modulus or a hardener (see, for example, Japanese Patent Application Laid-Open (JP-A) Nos. 9-3161 (pp. 2-5), 9-235353 (pp. 2-7), and 11-140277 (pp. 2-11)). On the other hand, such an epoxy resin composition exhibiting low water absorption and low elastic modulus has a low crosslinking density and, thus, a molded product therefrom is soft immediately after the resin is cured. Consequently, in the continuous production thereof, the epoxy resin composition causes an inconvenience about the moldability thereof such as remaining of resin in a mold and, thus, has a problem that the productivity falls.

As a method for improving the productivity, the use of a releasing material having a high releasing effect is suggested (see, for example, JP-A No. 2002-80695 (pp. 2-5)). However, the releasing agent, which has a high releasing effect, is inevitably easy to come out to the surface of a molded product, and thus is disadvantageous in that the external appearance of the molded product becomes remarkably dirty, when molded products are continuously produced. As an epoxy resin composition excellent in the external appearance of molded products therefrom, a method of adding a silicone compound having a specific structure and other methods are suggested (see, for example, JP-A Nos. 2002-97344 (pp. 2-10), and 2001-310930 (pp. 2-8)). However, as the epoxy resin composition has an insufficient releasability, in continuous molding thereof, the resin remains in the air vent portion. Consequently, the epoxy resin composition has a molding trouble such as incomplete filling the mold with the resin and, thus, has a problem that the productivity falls. In light of the above-mentioned situation, it has been desired to develop an epoxy resin composition for semiconductor encapsulation which copes with all themes of solder heat resistance, releasability, continuous moldability, external appearance of molded products therefrom, and stain on a mold surface.

### DISCLOSURE OF THE INVENTION

The present invention has been made to solve problems as described above, and an object thereof is to provide an epoxy resin composition for semiconductor encapsulation which is good in solder heat resistance, copes with all themes of releasability, continuous moldability, external appearance of molded product and stain on a mold surface, and is excellent in productivity; and a semiconductor device.

Such an object is attained by the present invention described in the following [1] to [7]:

[1] An epoxy resin composition for semiconductor encapsulation comprising (A) an epoxy resin, (B) a phenolic resin, (C) (C-1) an organopolysiloxane having a carboxyl group and/or (C-2) a reaction product between an organopolysiloxane having a carboxyl group and an epoxy resin, and (D) a tri-fatty acid ester of glycerol.
[2] The epoxy resin composition for semiconductor encapsulation according to item [1], wherein the organopolysiloxane having a carboxyl group of the (C) has a structure represented by the formula (1): 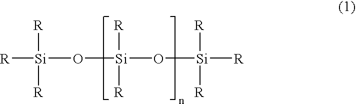
wherein at least one of ‘R’s is an organic group having a carbon number from 1 to 40 containing a carboxyl group in its structure, and the rest of ‘R’s are each a group selected from the group consisting of a hydrogen atom, a phenyl group, and a methyl group and may be the same or different, and ‘n’ represents a mean value and a positive number of from 1 to 50.
[3] The epoxy resin composition for semiconductor encapsulation according to item [1] or [2], wherein the (D) tri-fatty acid ester of glycerol is a tri-ester of glycerol combined with three molecules of a saturated fatty acid having a carbon number from 24 to 36.
[4] The epoxy resin composition for semiconductor encapsulation according to item [1], [2] or [3], wherein the weight ratio of the (C) component to the (D) component ((C)/(D)) is from 3/1 to 1/5.
[5] The epoxy resin composition for semiconductor encapsulation according to any one of items [1] to [4], wherein the (A) epoxy resin has a structure represented by the formula (2): 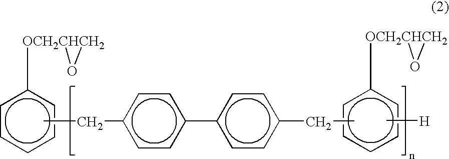
wherein ‘n’ represents a means value and a positive number of 1 to 10.
[6] The epoxy resin composition for semiconductor encapsulation according to any one of items [1] to [5], wherein the (B) phenolic resin has a structure represented by the formula (3): 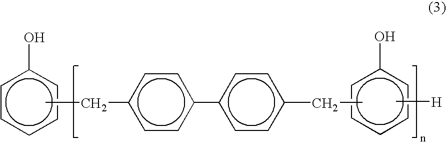
wherein ‘n’ represents a means value and a positive number of 1 to 10.
[7] A semiconductor device, which is formed by employing the epoxy resin composition for semiconductor encapsulation according to any one of items [1] to [6] to package a semiconductor element included therein.

### BRIEF DESCRIPTION OF THE DRAWING

FIG. 1 is a view illustrating a sectional structure of an example of a semiconductor device using an epoxy resin composition according to the present invention.

### BEST MODES FOR CARRYING OUT THE INVENTION

The present invention provides an epoxy resin composition for semiconductor encapsulation which is good in releasability, continuous moldability, and external appearance of a molded product therefrom and is hard to generate stain on a mold surface, thus exhibiting an excellent productivity when the composition is molded to package a semiconductor element included therein, and is excellent in solder heat resistance when a semiconductor device is packaged, by comprising an organopolysiloxane having a carboxyl group and a tri-fatty acid ester of glycerol as essential components.

The present invention is described in detail hereinafter.

The (A) epoxy resin used in the present invention means the whole of monomer, oligomer and polymer having in a single molecule thereof 2 or more epoxy groups. The molecular weight thereof, and the molecular structure thereof are not particularly limited. Examples thereof include biphenyl type epoxy resins, bisphenol type epoxy resins, stylbene type epoxy resin, phenol Novolak type epoxy resins, cresol Novolak type epoxy resins, triphenol methane type epoxy resins, alkyl-modified triphenol methane type epoxy resins, triazine-nucleus-containing epoxy resins, dicyclopentadiene-modified phenol type epoxy resins, phenol aralkyl type epoxy resins (such as having a phenylene structure and a biphenylene structure), and naphthol type epoxy resins. These may be used alone or in a mixture form.

Among them, phenol aralkyl type epoxy resins are preferable, phenol aralkyl type epoxy resins having a biphenylene structure or the like are more preferable, and an epoxy resin represented by the following formula (2) is even more preferable from the viewpoint of an improvement in solder crack resistance: 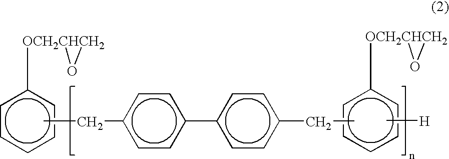
wherein ‘n’ represents a mean value and a positive number of 1 to 10.

The (B) phenolic resin used in the present invention means the whole of monomer, oligomer and polymer having in a single molecule thereof two or more phenolic hydroxyl groups. The molecular weight thereof, and the molecular structure thereof are not particularly limited. Examples thereof include phenol Novolak resins, cresol Novolak resins, dicyclopentadiene-modified phenolic resins, terpene-modified phenolic resins, triphenol methane type resins, phenol aralkyl resins (such as having a phenylene structure and a biphenylene structure), and naphthol aralkyl resins. These may be used alone or in a mixture form.

Among them, phenol aralkyl resins are preferable, phenol aralkyl resins having a biphenylene structure or the like are more preferable, and a phenolic resin represented by the following formula (3) is even more preferable from the viewpoint of an improvement in solder crack resistance: 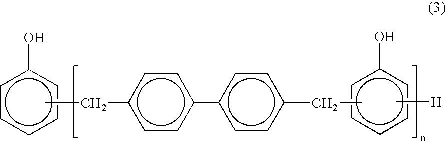
wherein ‘n’ represents a mean value and a positive number of 1 to 10. About the blend amount of the phenolic resin, the ratio of the number of epoxy groups in the whole of the epoxy resin to the number of the phenolic hydroxyl groups in the whole of the phenolic resin is preferably from 0.8 to 1.3.

The (C) component used in the present invention is (C-1) an organopolysiloxane having a carboxyl group and/or (C-2) a reaction product between an organopolysiloxane having a carboxyl group and an epoxy resin.

The organopolysiloxane having a carboxyl group, which is used as the (C) component in the invention, is an organopolysiloxane having in a single molecule thereof one or more carboxyl groups, and needs to be used together with a tri-fatty acid ester of glycerol. If the organopolysiloxane having a carboxyl group is used alone, the releasability becomes insufficient and the continuous moldability lowers. If the tri-fatty acid ester of glycerol is used alone, the external appearance of the resultant molded product is poor. The use of the organopolysiloxane having a carboxyl group together with the tri-fatty acid ester of glycerol makes it possible to make the tri-fatty acid ester of glycerol compatible therewith so that the external appearance of the molded product and the releasability are compatible and the continuous moldability becomes good. The blend ratio for combination of the (C) component of the invention to the (D) tri-fatty acid ester of glycerol ((C)/(D)) is desirably from 3/1 to 1/5 as the ratio by weight. This range has the largest advantageous effects.

The organopolysiloxane having a carboxyl group, which is used as the (C) component, is desirably an organopolysiloxane represented by the formula (1). ‘R’s in the formula (1) are each a organic group. At least one out of all of ‘R’s is a organic group having a carboxyl group and having a carbon number from 1 to 40 in its structure, and the rest of ‘R’s are each a group selected from the group consisting of a hydrogen atom, a phenyl group, and a methyl group and may be the same or different. If the carbon number of the organic group having a carboxyl group is over the upper limit, the compatibility thereof with the resin may deteriorate so that the external appearance of the resultant molded product may deteriorate. The carbon number of the organic group having a carboxyl group in the organopolysiloxane represented by the formula (1) means the total number of carbons in the hydrocarbon group and the carboxyl group in the organic group. 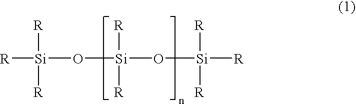
wherein at least one of ‘R’s is a organic group having a carbon number from 1 to 40 containing a carboxyl group, and the rest of ‘R’s are each a group selected from the group consisting of a hydrogen atom, a phenyl group, and a methyl group and may be the same or different, and ‘n’ represents a mean value and a positive number of from 1 to 50.

The organic group having a carbon number from 1 to 40 containing a carboxyl group out of ‘R’s is not particularly limited. If the group has a carboxyl group, the group may have another substitutent as long as the advantageous effects of the invention are not damaged, or the group may be a carboxyl group itself. The organic group having a carbon number from 1 to 40 containing a carboxyl group may be a group in which hydrogen in a hydrocarbon group is substituted with a carboxyl group. Examples of the hydrocarbon group include linear, branched and cyclic hydrocarbon groups, and further include saturated and unsaturated hydrocarbon groups. Examples of the cyclic hydrocarbon groups include aromatic hydrocarbon groups and alicyclic hydrocarbon groups. Among them, preferable are groups in which hydrogen in a linear saturated hydrocarbon group is substituted with a carboxyl group. Among them, more preferable are groups in which hydrogen in a linear saturated hydrocarbon group having a carbon number from 1 to 30 is substituted with a carboxyl group.

In the formula (1), n is a mean value and is a positive number of 1 to 50. The organopolysiloxane having a carboxyl group is preferably in an oil form. If the value of n is more than the upper limit, the viscosity of the organopolysiloxane itself becomes high so that the flowability may deteriorate. When the organopolysiloxane represented by the formula (1) is used, a fall in the flowability is not caused so that the external appearance of the resultant molded product becomes particularly good.

It is allowable to use, as the (C) component of the invention, (C-2) a reaction product between an organopolysiloxane having a carboxyl group and an epoxy resin. In this case, it is preferred to melt and react an organopolysiloxane having a carboxyl group beforehand with an epoxy resin and a curing accelerator. According to this, the mold after molding the composition continuously does not become dirty easily and the continuous moldability thereof becomes very good. The curing accelerator referred to herein may be any agent for accelerating curing reaction between a carboxyl group and an epoxy group, and can be used a material identical with a curing accelerator which will be described later and is for accelerating curing reaction between an epoxy group and a phenolic hydroxyl group.

The blend amount of the organopolysiloxane having a carboxyl group is preferably from 0.01 to 3% by weight of the total of the epoxy resin composition. If the amount is less than the lower limit, advantageous effects may be insufficiently produced so that external appearance dirt of the molded product may not be restrained. If the amount is more than the upper limit, the external appearance of the molded product may become dirty with the organopolysiloxane itself.

A different organopolysiloxane may be used together as long as effects based on the addition of the organopolysiloxane used in the invention, which has a carboxyl group, are not damaged.

The tri-fatty acid ester of glycerol used in the present invention is a triester obtained from glycerol and a saturated fatty acid, and may be called triglyceride. The ester is very good in releasability. In the case of monoesters and diesters thereof, the moisture resistance of the cured product of the epoxy resin is lowered by the effect of remaining hydroxyl groups so that a bad effect is produced on the solder heat resistance. Thus, the monoesters and diesters are not preferable. Specific examples of the tri-fatty acid ester of glycerol used in the invention include glycerol tricaproate, glycerol tricaprylate, glycerol tricaprate, glycerol trilaurate, glycerol trimyristate, glycerol tripalmitate, glycerol tristearate, glycerol triarachidate, glycerol tribehenate, glycerol trilignocerate, glycerol tricerotate, and glycerol trimontanate. The tri-fatty acid ester of glycerol used in the invention may be a single glyceride having, in a single molecule, the same fatty acid groups, or may be a mixed glyceride containing, in a single molecule thereof, two or three fatty acid groups. A mixture wherein two or more tri-fatty acid esters of glycerol are mixed may be used. Among them, desirable is a tri-fatty acid ester of glycerol resulting from a saturated fatty acid having a carbon number from 24 to 36 from the viewpoint of releasability and external appearance of a molded product. The carbon number of any saturated fatty acid in the invention means the total number of carbons in the alkyl group and the carboxyl group in the saturated fatty acid.

A different releasing agent may be used together as long as the effect based on the addition of the tri-fatty acid ester of glycerol used in the invention, which is obtained by esterifying glycerol and a saturated fatty acid, is not damaged. Examples thereof include natural waxes such as carnauba wax; synthetic waxes such as polyester wax; and metal salts of higher fatty acids, such as zinc stearate.

The blend amount of the tri-fatty acid ester of glycerol is preferably from 0.02 to 1% by weight of the total of the epoxy resin composition. If the amount is less than the lower limit, sufficient releasability cannot be obtained. If the amount is more than the upper limit, the external appearance of the molded product may become dirty and the adhesiveness may lower.

The epoxy resin composition of the invention comprises, as essential components, an epoxy resin, a phenolic hardener, an organopolysiloxane having a carboxyl group, and a tri-fatty acid ester of glycerol, and may comprise, as other main constituents, a curing accelerator, an inorganic filler and so on.

The curing accelerator used in the invention may be any material for accelerating curing reaction between an epoxy group and a phenolic hydroxyl. An accelerator which is generally used in an encapsulating material can be used. Examples thereof include diazabicycloalkenes such as 1,8-diazabicyclo(5,4,0)undecene-7, and derivatives thereof; organic phosphines such as triphenylphosphine and methyldiphenylphosphine; imidazole compounds such as 2-methylimidazole; and tetra-substituted phosphonium tetra-substituted borate such as tetraphenylphosphonium tetraphenylborate. These may be used alone or in a mixture form. The blend amount of the curing accelerator is preferably from 0.05 to 0.8% by weight of the total of the epoxy resin composition.

As the inorganic filler used in the invention, a material which is generally used in epoxy resin compositions for semiconductor encapsulation can be used. Examples thereof include fused silica, crystalline silica, talc, alumina, and silicon nitride. The filler that is most preferably used is spherical fused silica. These inorganic fillers may be used alone or in a mixture form. These may be surface-treated with a coupling agent. It is preferable that the shape of the inorganic filler is as completely-spherical as possible and the particle size distribution thereof is as broad as possible in order to improve flowability. The blend amount of the inorganic filler is preferably from 78 to 93% by weight of the total of the epoxy resin composition. If the amount is less than the lower limit, the composition cannot obtain sufficient solder resistance. If the amount is more than the upper limit, the composition may not obtain sufficient flowability.

The epoxy resin composition of the invention may be composed of an epoxy resin, a phenolic hardener, an organopolysiloxane having a carboxyl group, a tri-fatty acid ester of glycerol, a curing accelerator, and an inorganic filler, and further the following additives other than these may be appropriately incorporated thereinto if necessary: coupling agents, examples thereof including silane coupling agents such as epoxy silane, mercaptosilane, aminosilane, alkylsilane, ureidosilane and vinyl silane, titanate coupling agents, aluminum coupling agents, and aluminum/zirconium coupling agents; coloring agents such as carbon black; low-stress additives such as silicone oil and rubber; flame retardants such as brominated epoxy resin, antimony trioxide, aluminum hydroxide, magnesium hydroxide, zinc borate, zinc molybdate and phosphazene; and so on.

The epoxy resin composition of the invention can be obtained by mixing raw materials into a sufficient homogeneous state by use of a mixer or the like, melting and kneading the mixture with a heat roller, a kneader or the like, cooling the melted and kneaded mixture, and then pulverizing the resultant.

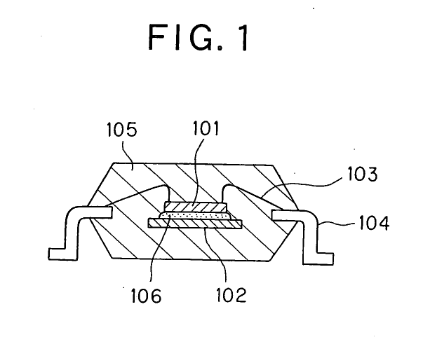

FIG. 1 is a view illustrating a sectional structure of an example of a semiconductor device which is formed by employing an epoxy resin composition according to the present invention to package a semiconductor element included therein. A semiconductor element 101 is fixed over a die pad 102 so as to interpose a cured die bonding material 106 therebetween. The semiconductor element 101 and lead frames 104 are connected thereto through gold wires 103. The semiconductor element 101 is encapsulated with an encapsulating resin 105. This semiconductor device is obtained by molding by a conventional molding process such as transfer molding, compression molding or injection molding, by use of the epoxy resin composition according to the invention having the above-mentioned constituents as the encapsulating resin 105.

### EXAMPLES

Examples of the present invention are described hereinafter. However, the invention is not limited thereto. Blending ratios are described in the unit of parts by weight.

### Example 1

The following were mixed:

| | |
|---|---|
| E-1: an epoxy resin represented by the form- | 8.13 parts by weight, |
| ula (2) (NC3000P manufactured by NIPPON | |
| KAYAKU CO., LTD., softening point: | |
| 58° C., epoxy equivalent: 274) | |

| | |
|---|---|
| | (2) |
| 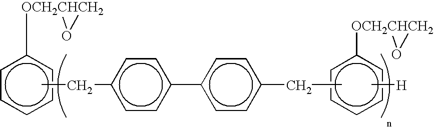 | |

| | |
|---|---|
| H-1: an epoxy resin represented by the form- | 5.47 parts by weight, |
| ula (3) (MEH-7851S manufactured by | |
| MEIWA PLASTIC INDUSTRIES, LTD., | |
| softening point: 107° C., hydroxyl | |
| equivalent: 203) | |

| | |
|---|---|
| | (3) |
| 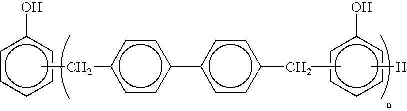 | |

| | |
|---|---|
| organopolysiloxane 1: an organopolysiloxane | 0.20 part by weight, |
| represented by the formula (4) | |

| | |
|---|---|
| | (4) |
| 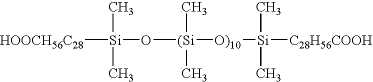 | |

| | |
|---|---|
| glycerol tristearate | 0.20 part by weight, |
| 1,8-diazabicyclo(5,4,0)undecene-7 (referred | 0.20 part by weight, |
| to as DBU hereinafter) | |
| spherical fused silica (average particle size: | 85.00 parts by weight, |
| 21 μm) | |
| coupling agent (γ-glycidoxypropyltrimeth- | 0.40 part by weight, and |
| oxysilane) | |
| carbon black | 0.40 part by weight. |

A heat roller was used to knead the mixture at 95° C. for 8 minutes, and the resultant was cooled and then pulverized to yield an epoxy resin composition. The resultant epoxy resin composition was evaluated by methods described below. The results are shown in Table 1.

[Evaluating Methods]

(1) Spiral flow: a low-pressure transfer molding machine was used to transfer the epoxy resin composition to a metal mold for the spiral flow measurement in accordance with EMMI-1-66 under the conditions of a mold temperature of 175° C., a transfer pressure of 6.9 MPa and a curing time of 120 seconds, thus measuring a flow length of the composition. The unit for presenting the spiral flow is “cm”. About the criterion thereof, a spiral flow of less than 70 cm and a spiral flow of 70 cm or more were made unacceptable (x) and acceptable (◯), respectively.

(2) Continuous moldability: an automatic low-pressure transfer molding machine was used to mold 80 pQFP's (CuL/F, package outer size: 14 mm×20 mm×2 mm thick), pad size: 6.5 mm×6.5 mm, chip size: 6.0 mm×6.0 mm) continuously till 700 shots at a mold temperature of 175° C., a transfer pressure of 9.6 MPa and a curing time of 70 seconds. About the criterion thereof, a composition making it possible to attain continuous molding till 700 shots without problems, such as incomplete filling, was judged as ⊚, a composition making it possible to attain continuous molding till 500 shots without problems, such as incomplete filling, was judged as ◯, and any composition other than the above was judged as x.

(3) External appearance of molded products and Stain on a mold surface: about the package and the mold after the 500 shots and the 700 shots in the above-mentioned continuous molding, stain thereon was evaluated by eye. About the package appearance judgment and stain on a mold surface criterion, a composition not becoming dirty till the 700 shots is represented as ⊚, a composition not becoming dirty till the 500 shots is represented as ◯, and a composition having become dirty is represented as x.

(4) Solder heat resistance: the packages molded by the above-mentioned continuous molding were post-cured at 175° C. for 8 hours. The resultant packages were subjected to humidifying treatment at 85° C. and a relatively humidity of 85% for 168 hours. Thereafter, 10 out of the packages were soaked into each of a solder tank of 240° C. and that of 260° C. for 10 seconds. The packages were observed with a microscope so as to calculate the crack generation rate [(crack generation rate)=(the number of external-crack-generated packages)/(the number of all the packages)×100]. The unit thereof is “%”. The number of the packages used for the evaluation was 20. The adhesion state of the interface between the semiconductor element and the epoxy resin composition was observed with an scanning acoustic tomograph. The presence or absence of delamination was evaluated. The number of the packages used for the evaluation was 20. About the criterion of solder cracking resistance, a composition giving a crack generation rate of 0% at 240° C. and 260° C. and giving no delamination was judged as ⊚, a composition giving a crack generation rate of 0% at 240° C. and giving no delamination was judged as ◯, and a composition giving cracking or delamination was judged as x.

### Examples 2 to 11 and Comparative Examples 1 to 6

In accordance with formulas shown in Tables 1 and 2, epoxy resin compositions were prepared in the same way as in Example 1. The compositions were evaluated in the same way as in Example 1. The results are shown in Tables 1 and 2.

Raw materials used in Examples and Comparative Examples other than that used in Example 1 are described hereinafter.

E-2: a biphenyl type epoxy resin (YX-4000 manufactured by Japan Epoxy Resins Co., Ltd., epoxy equivalent: 190 g/eq, melting point: 105° C.)

E-3: an ortho-cresol Novolak type epoxy resin (EOCN-1020 62 manufactured by NIPPON KAYAKU CO., LTD., epoxy equivalent: 200 g/eq, softening point: 62° C.)

H-2: a para-xylylene modified Novolak type phenolic resin (XLC-4L manufactured by Mitsui Chemicals, Inc., hydroxyl group equivalent: 168 g/eq, softening point: 62° C.)

Organopolysiloxane 2: an organopolysiloxane represented by the formula (5) 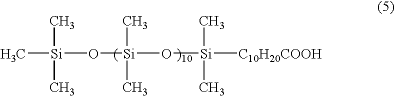
Organopolysiloxane 3: an organopolysiloxane represented by the formula (6): 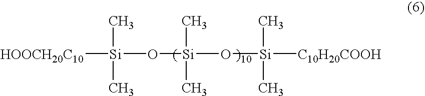
Organopolysiloxane 4: an organopolysiloxane represented by the formula (7): 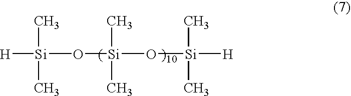
Melted reaction product A: at 140° C., 66.1 parts by weight of a bisphenol A type epoxy resin (YL-6810 manufactured by Japan Epoxy Resins Co., Ltd., epoxy equivalent: 170 g/eq, melting point: 47° C.) were heated and melted, and then thereto were added 33.1 parts by weight of the organopolysiloxane 3 (the organopolysiloxane represented by the formula (6)) and 0.8 part by weight of triphenylphosphine. The resultant was melted and mixed for 30 minutes to yield a melted reaction product A which corresponds to (C-2) a reaction product between an organopolysiloxane having carboxyl group and an epoxy resin.
Glycerol trimontanate
Glycerol dimontanate

Carnauba wax

TABLE 1

| | | | Examples | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| E-1 | | | 8.13 | 8.13 | 8.13 | 8.22 | 7.92 | 8.13 | 8.19 | 7.77 | 7.89 | | 9.26 |
| E-2 | | | | | | | | | | | | 3.81 | |
| E-3 | | | | | | | | | | | | 3.81 | |
| H-1 | | | 5.47 | 5.47 | 5.47 | 5.53 | 5.33 | 5.47 | 5.51 | 5.23 | 5.31 | | 6.24 |
| H-2 | | | | | | | | | | | | 5.98 | |
| Organopolysiloxane1 | | | 0.20 | | | | | | | | | | |
| Organopolysiloxane2 | | | | 0.20 | | | | | | | | | |
| Organopolysiloxane3 | | | | | 0.20 | 0.05 | 0.55 | 0.20 | 0.20 | 0.20 | | 0.20 | 2.60 |
| Organopolysiloxane4 | | | | | | | | | | | | | |
| Melted reaction product A | | | | | | | | | | | 0.60 | | |
| Glycerol tristearate | | | 0.20 | 0.20 | 0.20 | 0.20 | 0.20 | | | | | 0.20 | 0.90 |
| Glycerol trimontanate | | | | | | | | 0.20 | 0.10 | 0.80 | 0.20 | | |
| Glycerol dimontanate | | | | | | | | | | | | | |
| Carnauba wax | | | | | | | | | | | | | |
| DBU | | | 0.20 | 0.20 | 0.20 | 0.20 | 0.20 | 0.20 | 0.20 | 0.20 | 0.20 | 0.20 | 0.20 |
| Melted spherical silica | | | 85.00 | 85.00 | 85.00 | 85.00 | 85.00 | 85.00 | 85.00 | 85.00 | 85.00 | 85.00 | 80.00 |
| Coupling agent | | | 0.40 | 0.40 | 0.40 | 0.40 | 0.40 | 0.40 | 0.40 | 0.40 | 0.40 | 0.40 | 0.40 |
| Carbon black | | | 0.40 | 0.40 | 0.40 | 0.40 | 0.40 | 0.40 | 0.40 | 0.40 | 0.40 | 0.40 | 0.40 |
| Spiral flow | | Value(cm) | 100 | 120 | 108 | 120 | 105 | 110 | 108 | 105 | 110 | 120 | 165 |
| | | Judgment | ◯ | ◯ | ◯ | ◯ | ◯ | ◯ | ◯ | ◯ | ◯ | ◯ | ◯ |
| Continuous moldability | | | ⊚ | ◯ | ⊚ | ⊚ | ⊚ | ⊚ | ◯ | ⊚ | ⊚ | ⊚ | ⊚ |
| Appearance of molded product | | | ⊚ | ⊚ | ⊚ | ◯ | ⊚ | ⊚ | ⊚ | ◯ | ⊚ | ⊚ | ⊚ |
| and Stain on a mold surface | | | | | | | | | | | | | |
| Solder heat | 240° C. | Crack generation | 0 | 0 | 0 | 0 | 0 | 0 | 0 | 0 | 0 | 0 | 0 |
| resistance | | rate (%) | | | | | | | | | | | |
| | | Delamination | N | N | N | N | N | N | N | N | N | N | N |
| | 260° C. | Crack generation | 0 | 0 | 0 | 0 | 0 | 0 | 0 | 0 | 0 | 25 | 25 |
| | | rate (%) | | | | | | | | | | | |
| | | Delamination | N | N | N | N | N | N | N | N | N | G | G |

| | | | | | | | | | | | |
|---|---|---|---|---|---|---|---|---|---|---|---|
| Judgment | ⊚ | ⊚ | ⊚ | ⊚ | ⊚ | ⊚ | ⊚ | ⊚ | ⊚ | ◯ | ◯ |

| | | | | | | | | | | | |
|---|---|---|---|---|---|---|---|---|---|---|---|
| Total judgment | ◯ | ◯ | ◯ | ◯ | ◯ | ◯ | ◯ | ◯ | ◯ | ◯ | ◯ |

N: Not generated, G: Generated

TABLE 2

| | | | Comparative Examples | | | | | |
|---|---|---|---|---|---|---|---|---|
| | | | 1 | 2 | 3 | 4 | 5 | 6 |
| E-1 | | | 8.25 | 8.25 | 8.13 | 8.13 | 8.13 | 8.37 |
| E-2 | | | | | | | | |
| E-3 | | | | | | | | |
| H-1 | | | 5.55 | 5.55 | 5.47 | 5.47 | 5.47 | 5.63 |
| H-2 | | | | | | | | |
| Organopolysiloxane1 | | | | | | | | |
| Organopolysiloxane2 | | | | | | | | |
| Organopolysiloxane3 | | | 0.20 | | | 0.20 | 0.20 | |
| Organopolysiloxane4 | | | | | 0.20 | | | |
| Melted reaction product A | | | | | | | | |
| Glycerol tristearate | | | | 0.20 | 0.20 | | | |
| Glycerol trimontanate | | | | | | | | |
| Glycerol dimontanate | | | | | | 0.20 | | |
| Carnauba wax | | | | | | | 0.20 | |
| DBU | | | 0.20 | 0.20 | 0.20 | 0.20 | 0.20 | 0.20 |
| Melted spherical silica | | | 85.00 | 85.00 | 85.00 | 85.00 | 85.00 | 85.00 |
| Coupling agent | | | 0.40 | 0.40 | 0.40 | 0.40 | 0.40 | 0.40 |
| Carbon black | | | 0.40 | 0.40 | 0.40 | 0.40 | 0.40 | 0.40 |
| Spiral flow | | Value(cm) | 105 | 115 | 100 | 118 | 103 | 95 |
| | | Judgment | ◯ | ◯ | ◯ | ◯ | ◯ | ◯ |
| Continuous moldability | | | X | ◯ | ◯ | X | X | X |
| Appearance of molded product and | | | ◯ | X | X | ◯ | ◯ | X |
| Stain on a mold surface | | | | | | | | |
| Solder heat | 240° C. | Crack generation rate (%) | 0 | 0 | 0 | 0 | 0 | 0 |
| resistance | | Delamination | N | N | N | N | N | N |
| | 260° C. | Crack generation rate (%) | 0 | 0 | 0 | 0 | 0 | 0 |
| | | Delamination | N | N | N | N | N | N |

| | | | | | | |
|---|---|---|---|---|---|---|
| Judgment | ⊚ | ⊚ | ⊚ | ⊚ | ⊚ | ⊚ |

| | | | | | | |
|---|---|---|---|---|---|---|
| Total judgment | X | X | X | X | X | X |

N: Not generated, G: Generated

### INDUSTRIAL APPLICABILITY

According to the present invention, good solder heat resistance is exhibited at the time of packaging a semiconductor device, and further problems such releasability, continuous moldability, external appearance of molded product and stain on a mold surface, which are defects in the prior art, can be solved. Therefore, the invention is preferably used for industrial resin-encapsulated type semiconductor devices, in particular, resin-encapsulated type semiconductor devices for surface mounting.

1. An epoxy resin composition for semiconductor encapsulation comprising (A) an epoxy resin, (B) a phenolic resin, (C)(C-1) an organopolysiloxane having a carboxyl group and/or (C-2) a reaction product between an organopolysiloxane having a carboxyl group and an epoxy resin, and (D) a tri-fatty acid ester of glycerol.

2. The epoxy resin composition for semiconductor encapsulation according to claim 1, wherein the organopolysiloxane having the carboxyl group of the (C) has a structure represented by the formula (1): 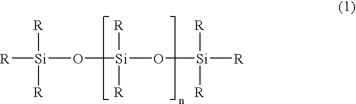
wherein at least one of ‘R’ is an organic group having carbon number from 1 to 40 containing a carboxyl group in its structure, and the rest of the ‘R’ are a group selected from the group consisting of a hydrogen atom, a phenyl group, and a methyl group and may be the same or different. ‘n’ represents a mean value and a positive number of from 1 to 50.

3. The epoxy resin composition for semiconductor encapsulation according to claim 1, wherein the (D) tri-fatty acid ester of glycerol is a tri-ester of glycerol combined with three molecules of a saturated fatty acid having a carbon number from 24 to 36.

4. The epoxy resin composition for semiconductor encapsulation according to claim 1, wherein the weight ratio of the (C) component to the (D) component ((C)/(D)) is from 3/1 to 1/5.

5. The epoxy resin composition for semiconductor encapsulation according to claim 1, wherein the (A) epoxy resin has a structure represented by the formula (2): 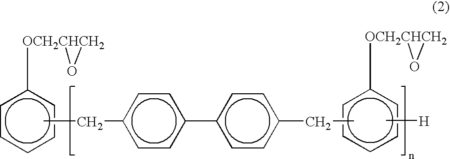
wherein ‘n’ represents a mean value and a positive number of 1 to 10.

6. The epoxy resin composition for semiconductor encapsulation according to claim 1, wherein the (B) phenolic resin has a structure represented by the formula (3): 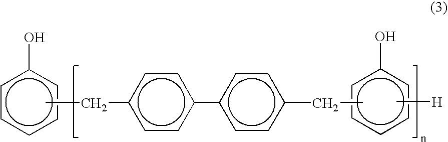
wherein ‘n’ represents a mean value and a positive number of 1 to 10.

7. A semiconductor device, comprising a semiconductor element encapsulated by the epoxy resin composition according to claim 1.
